(19) United States
(12) Patent Application Publication
(10) Pub. No.: US 2013/0194389 A1
(43) Pub. Date: Aug. 1, 2013

(54) HEAD-MOUNTED DISPLAY DEVICE TO MEASURE ATTENTIVENESS

(71) Applicants: Ben Vaught, Seattle, WA (US); Ben Sugden, Woodinville, WA (US); Stephen Latta, Seattle, WA (US); John Clavin, Seattle, WA (US)

(72) Inventors: Ben Vaught, Seattle, WA (US); Ben Sugden, Woodinville, WA (US); Stephen Latta, Seattle, WA (US); John Clavin, Seattle, WA (US)

(21) Appl. No.: 13/363,244

(22) Filed: Jan. 31, 2012

(51) Int. Cl. H04N 7/18; H04N 13/02

(52) U.S. Cl. 348/47; 348/78; 348/E07.085; 348/E13.074

(57) ABSTRACT

A method for assessing a attentiveness to visual stimuli received through a head-mounted display device. The method employs first and second detectors arranged in the head-mounted display device. An ocular state of the wearer of the head-mounted display device is detected with the first detector while the wearer is receiving a visual stimulus. With the second detector, the visual stimulus received by the wearer is detected. The ocular state is then correlated to the wearer's attentiveness to the visual stimulus.

### BACKGROUND

Mediated information in the form of visual stimuli is increasingly ubiquitous in today's world. No person can be expected to pay attention to all of the information directed towards them—whether for educational, informational, or marketing purposes. Nevertheless, mediated information that does not reach an attentive audience amounts to wasted effort and expense. Information purveyors, therefore, have a vested interest to determine which information is being received attentively, and which is being ignored, so that subsequent efforts to mediate the information can be refined.

In many cases, gauging a person's attentiveness to visual stimuli is an imprecise and time-consuming task, requiring dedicated equipment and/or complex analysis. Accordingly, information is often mediated in an unrefined manner, with no assurance that it has been received attentively.

### SUMMARY

One embodiment of this disclosure provides a method for assessing attentiveness to visual stimuli received through a head-mounted display device. The method employs first and second detectors arranged in the head-mounted display device. An ocular state of the wearer of the head-mounted display device is detected with the first detector while the wearer is receiving a visual stimulus. With the second detector, the visual stimulus received by the wearer is detected. The ocular state is then correlated to the wearer's attentiveness to the visual stimulus.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows aspects of an example augmented-reality (AR) environment in accordance with an embodiment of this disclosure.

FIGS. 2 and 3 show example head-mounted display (HMD) devices in accordance with embodiments of this disclosure.

FIG. 4 shows aspects of example optical componentry of an HMD device in accordance with an embodiment of this disclosure.

FIG. 5 shows additional aspects of an HMD device in accordance with an embodiment of this disclosure.

FIG. 6 illustrates an example method for assessing attentiveness to visual stimuli in accordance with an embodiment of this disclosure.

FIG. 7 illustrates an example method for detecting the ocular state of a wearer of an HMD device while the wearer is receiving a visual stimulus, in accordance with an embodiment of this disclosure.

FIGS. 8 and 9 illustrate example methods for detecting a visual stimulus received by a wearer of an HMD device in accordance with embodiments of this disclosure.

FIG. 10 illustrates an example method to correlate the ocular state of a wearer of an HMD device to the wearer's attentiveness to a visual stimulus, in accordance with an embodiment of this disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

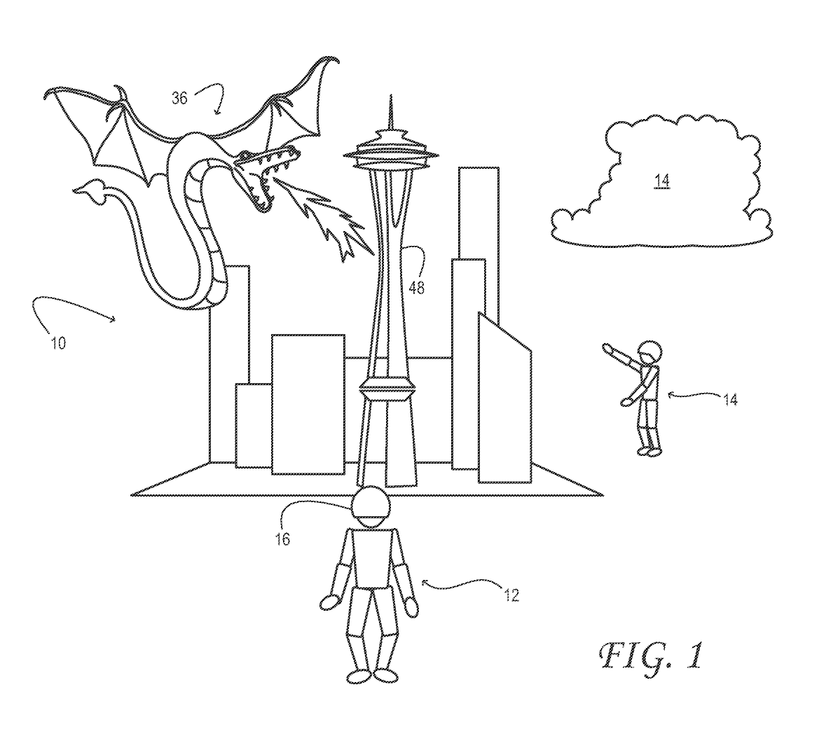

FIG. 1 shows aspects of an example augmented-reality (AR) environment 10. In particular, it shows AR participants 12 and 14 interacting with various real and virtual objects in an exterior space. In other scenarios, the AR environment may include more or fewer AR participants in an interior space. To experience an augmented reality, the AR participants may employ an AR system having suitable display, sensory, and computing hardware. In the embodiment shown in FIG. 1, the AR system includes cloud 14 and head-mounted display (HMD) devices 16. ‘Cloud’ is a term used to describe a computer system accessible via a network and configured to provide a computing service. In the present context, the cloud may include any number of mainframe and/or server computers.

Each HMD device 16 enables its wearer to view real-world imagery in combination with context-relevant, computer-generated imagery. imagery from both sources is presented in the wearer's field of view, and may appear to share the same physical space. The HMD device may be fashioned as goggles, a helmet, a visor, or other eyewear. When configured to present two different display images, one for each eye, the HMD device may be used for stereoscopic, three-dimensional (3D) display. Each HMD device may include eye-tracking technology to determine the wearer's line of sight, so that the computer-generated imagery may be positioned correctly within the wearer's field of view.

Each HMD device 16 may also include a computer, in addition to various other componentry, as described hereinafter. Accordingly, the AR system may be configured to run one or more computer programs. Some of the computer programs may run on HMD devices 16; others may run on cloud 14. Cloud 14 and HMD devices 16 are operatively coupled to each other via one or more wireless communication links. Such links may include cellular, Wi-Fi, and others.

In some scenarios, the computer programs providing an AR experience may include a game. More generally, the programs may be any that combine computer-generated imagery with the real-world imagery viewed by the AR participants. A realistic AR experience may be achieved with each AR participant viewing his environment naturally, through passive optics of the HMD device. The computer-generated imagery, meanwhile, is projected into the same field of view in which the real-world imagery is received. As such, the AR participant's eyes receive light from the objects observed as well as light generated by the HMD device.

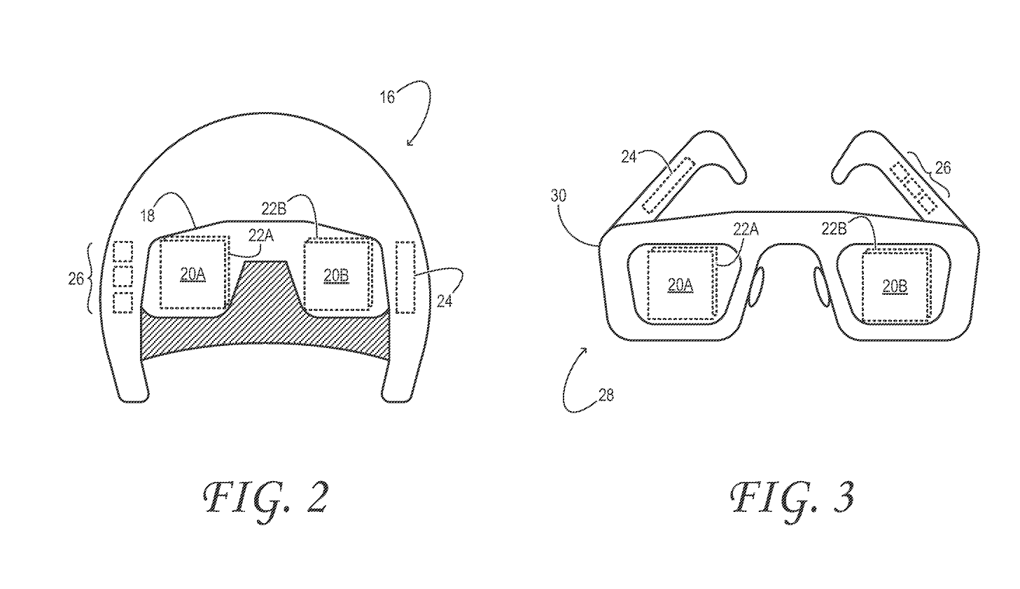

FIG. 2 shows an example HMD device 16 in one embodiment. HMD device 16 is a helmet having a visor 18. Between the visor and each of the wearer's eyes is arranged an imaging panel 20 and an eye tracker 22: imaging panel 20A and eye tracker 22A are arranged in front of the right eye; imaging panel 20B and eye tracker 22B are arranged in front of the left eye. Although the eye trackers are arranged behind the imaging panels in the drawing, they may instead be arranged in front of the imaging panels, or distributed in various locations within the HMD device. HMD device 16 also includes controller 24 and sensors 26. The controller is operatively coupled to both imaging panels, to both eye trackers, and to the sensors.

Each imaging panel 20 is at least partly transparent, providing a substantially unobstructed field of view in which the wearer can directly observe his physical surroundings. Each imaging panel is configured to present, in the same field of view, a computer-generated display image. Controller 24 controls the internal componentry of imaging panels 20A and 20B in order to form the desired display images. In one embodiment, controller 24 may cause imaging panels 20A and 20B to display the same image concurrently, so that the wearer's right and left eyes receive the same image at the same time. In another embodiment, the imaging panels may project slightly different images concurrently, so that the wearer perceives a stereoscopic, i.e., three-dimensional image. In one scenario, the computer-generated display image and various real images of objects sighted through an imaging panel may occupy different focal planes. Accordingly, the wearer observing a real-world object may have to shift his corneal focus in order to resolve the display image. In other scenarios, the display image and at least one real image may share a common focal plane.

In the HMD devices disclosed herein, each imaging panel 20 is also configured to acquire video of the surroundings sighted by the wearer. The video may be used to establish the wearer's location, what the wearer sees, etc. The video acquired by the imaging panel is received in controller 24. The controller may be further configured to process the video received, as disclosed hereinafter.

Each eye tracker 22 is a detector configured to detect an ocular state of the wearer of HMD device 16 when the wearer is receiving a visual stimulus. It may locate a line of sight of the wearer, measure an extent of iris closure, and/or record a sequence of saccadic movements of the wearer's eye. If two eye trackers are included, one for each eye, they may be used together to determine the focal plane of the wearer based on the point of convergence of the lines of sight of the wearer's left and right eyes. This information may be used for placement of one or more virtual images, for example.

FIG. 3 shows another example HMD device 28. HMD device 28 is an example of AR eyewear. It may closely resemble an ordinary pair of eyeglasses or sunglasses, but it too includes imaging panels 20A and 20B, and eye trackers 22A and 22B. HMD device 28 includes wearable mount 30, which positions the imaging panels and eye trackers a short distance in front of the wearer's eyes. In the embodiment of FIG. 3, the wearable mount takes the form of conventional eyeglass frames.

No aspect of FIG. 2 or 3 is intended to be limiting in any sense, for numerous variants are contemplated as well. In some embodiments, for example, a vision system separate from imaging panels 20 may be used to acquire video of what the wearer sees. In some embodiments, a binocular imaging panel extending over both eyes may be used instead of the monocular imaging panel shown in the drawings. Likewise, an HMD device may include a binocular eye tracker. In some embodiments, an eye tracker and imaging panel may be integrated together, and may share one or more optics.

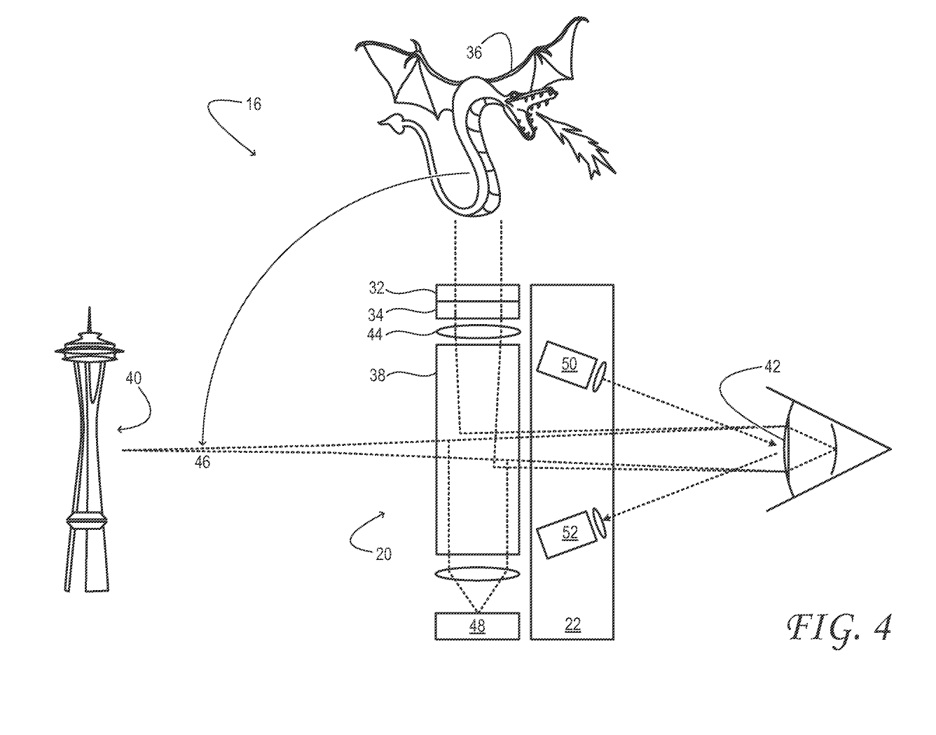

FIG. 4 shows aspects of example optical componentry of HMD device 16. In the illustrated embodiment, imaging panel 20 includes illuminator 32 and image former 34. The illuminator may comprise a white-light source, such as a white light-emitting diode (LED). The illuminator may further comprise an optic suitable for collimating the emission of the white-light source and directing the emission into the image former. The image former may comprise a rectangular array of light valves, such as a liquid-crystal display (LCD) array. The light valves of the array may be arranged to spatially vary and temporally modulate the amount of collimated light transmitted therethrough, so as to form pixels of a display image 36. Further, the image former may comprise suitable light-filtering elements in registry with the light valves so that the display image formed is a color image. The display image 36 may be supplied to imaging panel 20 as any suitable data structure—a digital-image or digital-video data structure, for example.

In another embodiment, illuminator 32 may comprise one or more modulated lasers, and image former 34 may be a moving optic configured to raster the emission of the lasers in synchronicity with the modulation to form display image 36. In yet another embodiment, image former 34 may comprise a rectangular array of modulated color LEDs arranged to form the display image. As each color LED array emits its own light, illuminator 32 may be omitted from this embodiment. The various active components of imaging panel 20, including image former 34, are operatively coupled to controller 24. In particular, the controller provides suitable control signals that, when received by the image former, cause the desired display image to be formed.

Continuing in FIG. 4, imaging panel 20 includes multipath optic 38. The multipath optic is suitably transparent, allowing external imagery—e.g., a real image 40 of a real object—to be sighted directly through it. Image former 34 is arranged to project display image 36 into the multipath optic. The multipath optic is configured to reflect the display image to pupil 42 of the wearer of HMD device 16. To reflect the display image as well as transmit the real image to pupil 42, multipath optic 38 may comprise a partly reflective, partly transmissive structure, such as an optical beam splitter. In one embodiment, the multipath optic may comprise a partially silvered mirror. In another embodiment, the multipath optic may comprise a refractive structure that supports a thin turning film.

In some embodiments, multipath optic 38 may be configured with optical power. It may be used to guide display image 36 to pupil 42 at a controlled vergence, such that the display image is provided as a virtual image in the desired focal plane. In other embodiments, the multipath optic may contribute no optical power: the position of the virtual display image may be determined instead by the converging power of lens 44. In one embodiment, the focal length of lens 44 may be adjustable, so that the focal plane of the display image can be moved back and forth in the wearer's field of view. In FIG. 4, an apparent position of virtual display image 36 is shown, by example, at 46.

The reader will note that the terms ‘real’ and ‘virtual’ each have plural meanings in the technical field of this disclosure. The meanings differ depending on whether the terms are applied to an object or to an image. A ‘real object’ is one that exists in an AR participant's surroundings. A ‘virtual object’ is a computer-generated construct that does not exist in the AR participant's physical surroundings, but may be experienced (seen, heard, etc.) via suitable AR technology. Quite distinctly, a ‘real image’ is an image that coincides with the physical object it derives from, whereas a ‘virtual image’ is an image formed at a different location than the physical object it derives from.

As shown in FIG. 4, imaging panel 20 also includes camera 48. The camera is configured to detect the real imagery sighted by the wearer of HMD device 16. The optical axis of the camera may be aligned parallel to the line of sight of the wearer of HMD device 16, such that the camera acquires video of the external imagery sighted by the wearer. Such imagery may include real image 40 of a real object, as noted above. The video acquired may comprise a time-resolved sequence of images of spatial resolution and frame rate suitable for the purposes set forth herein. Controller 24 may be configured to process the video to enact aspects of the methods set forth herein.

As HMD device 16 includes two imaging panels—one for each eye—it may also include two cameras. More generally, the nature and number of the cameras may differ in the various embodiments of this disclosure. One or more cameras may be configured to provide video from which a time-resolved sequence of three-dimensional depth maps is obtained via downstream processing. As used herein, the term ‘depth map’ refers to an array of pixels registered to corresponding regions of an imaged scene, with a depth value of each pixel indicating the depth of the corresponding region. ‘Depth’ is defined as a coordinate parallel to the optical axis of the camera, which increases with increasing distance from the camera. In some embodiments, one or more cameras may be separated from and used independently of one or more imaging panels.

In one embodiment, camera 48 may be a right or left camera of a stereoscopic vision system. Time-resolved images from both cameras may be registered to each other and combined to yield depth-resolved video. In other embodiments, HMD device 16 may include projection componentry (not shown in the drawings) that projects onto the surroundings a structured infrared illumination comprising numerous, discrete features (e.g., lines or dots). Camera 48 may be configured to image the structured illumination reflected from the surroundings. Based on the spacings between adjacent features in the various regions of the imaged surroundings, a depth map of the surroundings may be constructed.

hi other embodiments, the projection componentry in HMD device 16 may be used to project a pulsed infrared illumination onto the surroundings. Camera 48 may be configured to detect the puked illumination reflected from the surroundings. This camera, and that of the other imaging panel, may each include an electronic shutter synchronized to the pulsed illumination, but the integration times for the cameras may differ, such that a pixel-resolved time-of-flight of the pulsed illumination, from the source to the surroundings and then to the cameras, is discernable from the relative amounts of light received in corresponding pixels of the two cameras. In still other embodiments, the vision unit may include a color camera and a depth camera of any kind. Time-resolved images from color and depth cameras may be registered to each other and combined to yield depth-resolved color video. From the one or more cameras in HMD device 16, image data may be received into process componentry of controller 24 via suitable input-output componentry.

FIG. 4 also shows aspects of eye tracker 22. The eye tracker includes illuminator 50 and detector 52. The illuminator may include a low-power infrared LED or diode laser. In one embodiment, the illuminator may provide periodic illumination in the form of narrow pulses—e.g., 1 microsecond pulses spaced 50 microseconds apart. The detector may be any camera system suitable for imaging the wearer's eye in enough detail to resolve the pupil. More particularly, the resolution of the detector may he sufficient to enable estimation of the position of the pupil with respect to the eye orbit, as well as the extent of closure of the iris. In one embodiment, the aperture of the detector is equipped with a wavelength filter matched in transmittance to the output wavelength band of the illuminator. Further, the detector may include an electronic ‘shutter’ synchronized to the puked output of the illuminator. The frame rate of the detector may be sufficiently fast to capture a sequence of saccadic movements of the eye. In one embodiment, the frame rate may be in excess of 240 frames per second. In another embodiment, the frame rate may be in excess of 1000 frames per second.

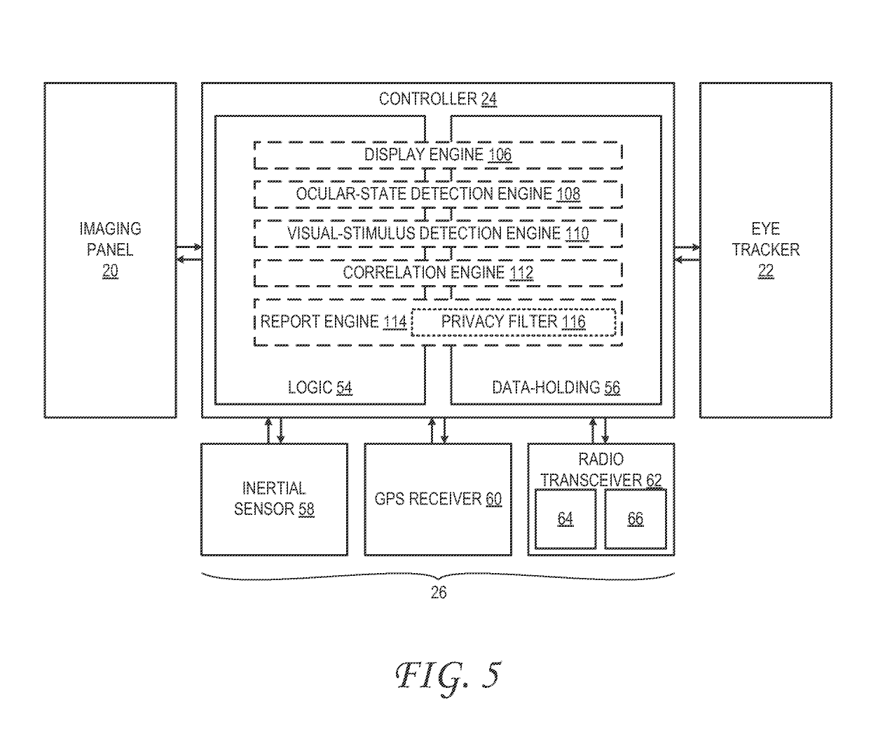

FIG. 5 shows additional aspects of HMD device 16 in one example embodiment. In particular, this drawing shows controller 24 operatively coupled to imaging panel 20, eye tracker 22, and sensors 26. Controller 24 includes logic subsystem 54 and data-holding subsystem 56, which are further described hereinafter. In the embodiment of FIG. 5, sensors 26 include inertial sensor 58, global-positioning system (GPS) receiver 60, and radio transceiver 62. In some embodiments, the controller may include still other sensors, such as a gyroscope, and/or a barometric pressure sensor configured for altimetry.

From the integrated responses of the various sensors of HMD device 16, controller 24 may track the movement of the HMD device within the wearer's environment. Used separately or together, the inertial sensor, the global-positioning system receiver, and the radio transceiver may be configured to locate the wearer's line of sight within a geometric model of that environment. Aspects of the model—surface contours, locations of objects, etc.—may be accessible by the HMD device through a wireless communication link. In one embodiment, the model of the environment may be hosted in cloud 14.

In some examples, radio transceiver 62 may be a Wi-Fi transceiver; it may include radio transmitter 64 and radio receiver 66. The radio transmitter emits a signal that may be received by compatible radio receivers in the controllers of other HMD devices—viz., those worn by other AR participants sharing the same environment. Based on the strengths of the signals received and/or information encoded in such signals, each controller 24 may be configured to determine proximity to nearby HMD devices. In this manner, certain geometric relationships between the lines of sight of a plurality of AR participants may be estimated. For example, the distance between the origins of the lines of sight of two nearby AR participants may be estimated. Increasingly precise location data may be computed for an HMD device of a given AR participant when that device is within range of HMD devices of two or more other AR participants present at known coordinates. With a sufficient number of AR participants at known coordinates, the coordinates of the given AR participant may be determined—e.g., by triangulation.

In another embodiment, radio receiver 66 may be configured to receive a signal from a circuit embedded in an object. in one scenario, the signal may be encoded in a manner that identifies the object and/or its coordinates. A signal-generating circuit embedded in an object may be used like radio receiver 66, to bracket the location of an HMD device within an environment.

Proximity sensing as described above may be used to establish the location of one AR participant's HMD device relative to another's. Alternatively, or in addition, GPS receiver 60 may be used to establish the absolute or global coordinates of any HMD device. In this manner, the origin of an AR participant's line of sight may be determined within a coordinate system. Use of the GPS receiver for this purpose may be predicated on the informed consent of the AR participant wearing the HMD device. Accordingly, the methods disclosed herein may include querying each AR participant for consent to share his or her location.

In some embodiments, GPS receiver 60 may not return the precise coordinates for an HMD device. It may, however, provide a zone or bracket within which the HMD can be located more precisely, according to other methods disclosed herein. For instance, a GPS receiver will typically provide latitude and longitude directly, but may rely on map data for height. Satisfactory height data may not be available for every AR environment contemplated herein, so the other sensory data may be used as well.

In addition to providing a premium AR experience, the configurations described above may be used for certain other purposes. Envisaged herein is a scenario in which AR technology has become pervasive in everyday living. In this scenario, a person may choose to wear an HMD device not only to play games, but also in various professional and social settings. Worn at a party, for instance, an HMD device may help its wearer to recognize faces. The device may discreetly display information about people that the wearer encounters, in order to lessen the awkwardness of an unexpected meeting: “Her name is Candy. Last meeting Jul. 18, 2011, Las Vegas, Nev.” Worn at the workplace, the HMD device may display incoming email or text messages, remind it's wearer of urgent calendar items, etc.

In scenarios in which an HMD device is worn to augment everyday reality, data from the device may be used to determine the extent to which imagery sighted by the wearer captures the wearer's attention. Predicated on the wearer's consent, the HMD device may report such information to interested parties.

In one illustrative example, a customer may wear an HMD device while browsing a sales lot of an automobile dealership. The HMD device may be configured to determine how long its wearer spends looking at each vehicle. It may also determine whether, or how closely, the customer reads the window sticker. Before, during, or after browsing the sales lot, the customer may use the HMD device to view an internet page containing information about one or more vehicles—manufacturer specifications, owner reviews, promotions from other dealerships, etc. The HMD device may be configured to store data identifying the virtual imagery viewed by the wearer—e.g., an internet address, the visual content of a web page, etc. It may determine the length of time, or how closely, the wearer studies such virtual imagery.

A computer program running within the HMD device may use the information collected to gauge the customer's interest in each vehicle looked at—i.e., to assign a metric for interest in that vehicle. With the wearer's consent, that information may be provided to the automobile dealership. By analyzing information from a plurality of customers that have browsed the sales lot wearing HMD devices, the dealership may be better poised to decide which vehicles to display more prominently, to promote via advertising, or to offer at a reduced price.

The narrative above describes only one example scenario, but numerous others are contemplated as well. The approach outlined herein is applicable to practically any retail or service setting in which a customer's attentiveness to selected visual stimuli can be used to focus marketing or customer-service efforts. It is equally applicable to informational and educational efforts, where the attentiveness being assessed is that of a learner, rather than a customer. It should be noted that previous attempts to measure attentiveness typically have not utilized multiple user cues and context-relevant information. By contrast, the present approach does not look ‘just’ at the eyes, but folds in multiple sights, sounds and user cues to effectively measure attentiveness.

It will appreciated, therefore, that the configurations described herein provide a system for assessing the attentiveness of a wearer of an HMD device to visual stimuli received through the HMD device. Further, these configurations enable various methods for assessing the wearer's attentiveness. Some such methods are now described, by way of example, with continued reference to the above configurations. It will be understood, however, that the methods here described, and others within the scope of this disclosure, may be enabled by other configurations as well. Naturally, each execution of a method may change the entry conditions for a subsequent execution and thereby invoke a complex decision-making logic. Such logic is fully contemplated in this disclosure. Further, some of the process steps described and/or illustrated herein may, in some embodiments, be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

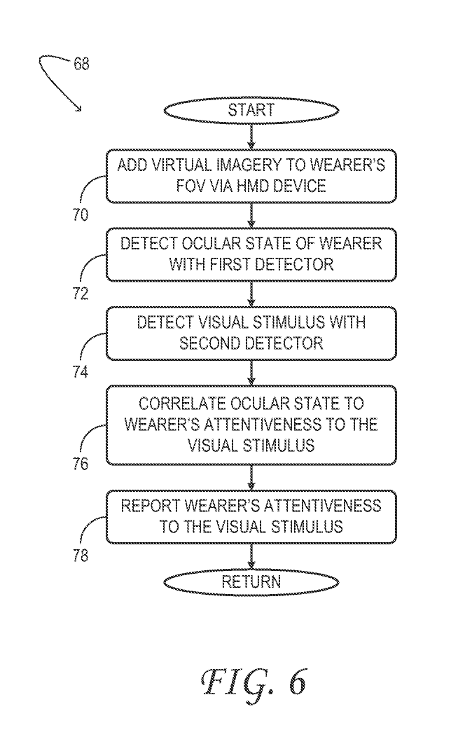

FIG. 6 illustrates an example method 68 for assessing the attentiveness of a wearer of an HMD device to visual stimuli received through the HMD device. At 70 of method 68, virtual imagery is added to the wearer's field of view (FOV) via the HMD device. The virtual image may include a text or email message, a web page, or a holographic image, for example.

At 72 an ocular state of wearer is detected with a first detector arranged in the HMD device, while the wearer is receiving a visual stimulus. The visual stimulus referred to in this method may include the virtual imagery added (at 70) to the wearer's field of view, in addition to real imagery naturally present in the wearer's field of view. The particular ocular state detected may differ in the different embodiments of this disclosure. It may include a pupil orientation, an extent of iris closure, and/or a sequence of saccadic movements of the eye, as further described hereinafter.

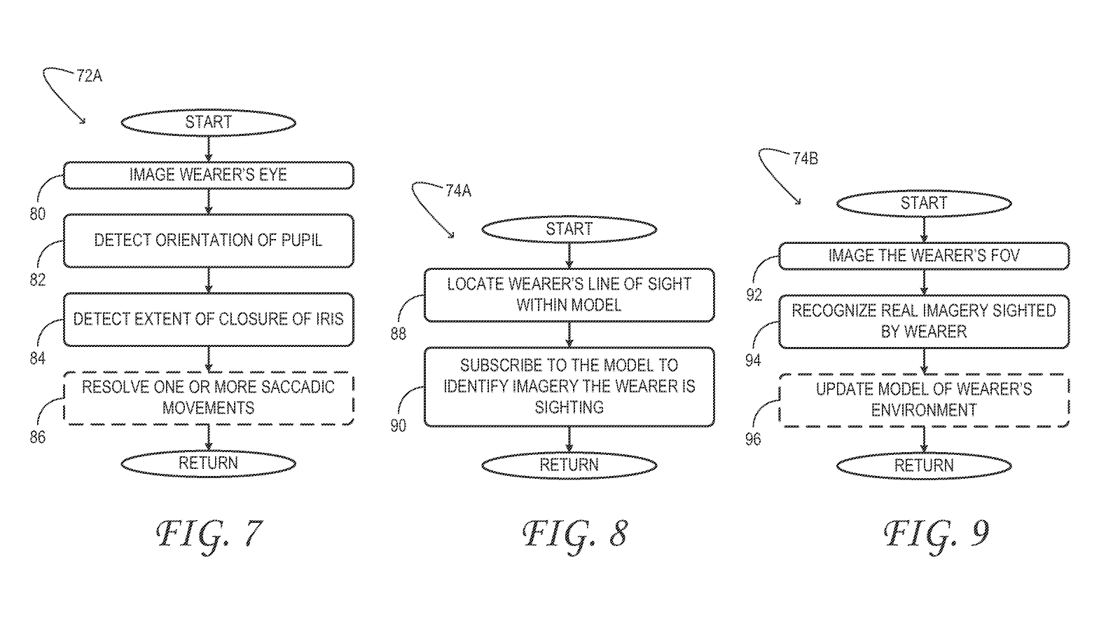

At 74 the visual stimulus received by the wearer of the HMD device is detected with second detector also arranged in the HMD device. As noted above, the visual stimulus may include real as well as virtual imagery. Virtual imagery may be detected by parsing the display content from a display engine running on the HMD device. To detect real imagery, at least two different approaches may be used. A first approach relies on subscription to a geometric model of the wearer's environment. A second approach relies on object recognition. Example methods based on these approaches are described hereinafter, with reference to FIGS. 8 and 9.

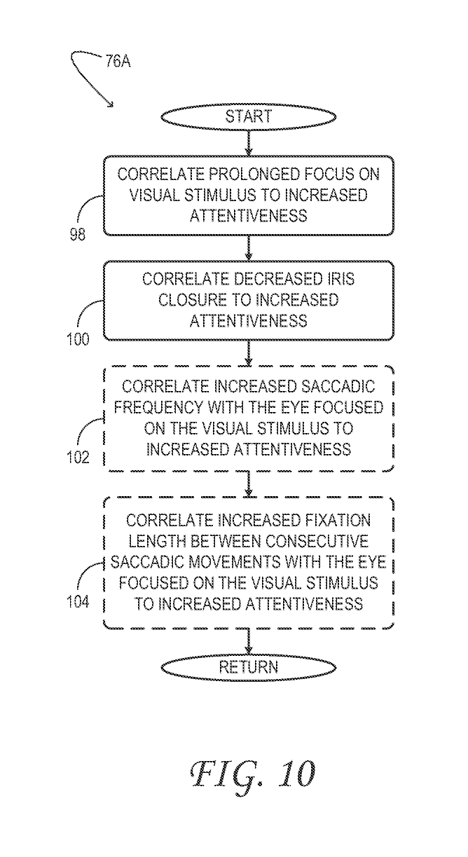

Continuing in FIG. 6, at 76 the ocular state of the wearer detected by the first detector is correlated to the wearer's attentiveness to the visual stimulus received. This disclosure embraces numerous metrics and formulas that may be used to correlate the ocular state of the wearer to the wearer's attentiveness. A few specific examples are given below, with reference to FIG. 10. In addition, while the wearer's ocular state may be the primary measurable parameter, other information may also enter into the correlation. For example, some stimuli may have an associated audio component. Attentiveness to such a stimulus may be evidenced by the wearer increasing the volume of an audio signal provided through the HMD device. However, when the audio originates from outside of the HMD device, lowering the volume may signal increased attentiveness. Rapid shaking as measured by an inertial sensor may signify that the wearer agitated or in motion, making it less likely that the wearer is engaged by the stimulus. Likewise, above-threshold audio noise (unrelated to the stimulus) may indicate that the wearer is more likely to be distracted from the stimulus.

At 78 of method 68, the output of the correlation—viz., the wearer's attentiveness to the visual stimulus received—is reported to a consumer of such information. The wearer's attentiveness may be reported via wireless communications componentry arranged in the HMD device.

Naturally, any information acquired via the HMD device—e.g., the subject matter sighted by the wearer of the device and the ocular states of the wearer—may not be shared without the express consent of the wearer. Furthermore, a privacy filter may be embodied in the HMD device controller. The privacy filter may be configured to allow the reporting of attentiveness data within constraints—e.g., previously approved categories—authorized by the wearer, and to prevent the reporting of data outside those constraints. Attentiveness data outside those constraints may be discarded. For example, the wearer may be inclined to allow the reporting of data related to his attentiveness to vehicles viewed at an auto dealership, but not his attentiveness to the attractive salesperson at the dealership. In this manner, the privacy filter may allow for consumption of attentiveness data in a way that safeguards the privacy of the HMD device wearer.

FIG. 7 illustrates an example method 72A for detecting the ocular state of a wearer of an HMD device while the wearer is receiving a visual stimulus. Method 72A may be a more particular instance of block 72 of method 68.

At 80 of method 72A, the wearer's eye is imaged by a detector arranged in the HMD device. In one embodiment, the wearer's eye may be imaged 240 or more times per second, at a resolution sufficient for the purposes set forth herein. In a more particular embodiment, the wearer's eye may be imaged 1000 or more times per second.

At 82 the orientation of the wearer's pupil is detected. Depending on the direction in which the wearer is looking, the pupil may be centered at various points on the front surface of the eye. Such points may span a range of angles θ and a range of angles φ measured in orthogonal planes each passing through the center of the eye—one plane containing, and the other plane perpendicular to the interocular axis. Based on the pupil position, the line of sight from that eye may be determined—e.g., as the line passing through the center of the pupil and the center of the eye. Furthermore, if the line of sight of both eyes is determined, then the focal plane of the wearer can be estimated readily—e.g., as the plane containing the point of intersection of the two lines of sight and normal to a line constructed midway between the two lines of sight.

At 84 the extent of closure of the iris of one or both of the wearer's eyes is detected. The extent of closure of the iris can be detected merely by resolving the apparent size of the pupil in the acquired images of the wearer's eyes. At 86 one or more saccadic—i.e., short-duration, small angle—movements of the wearer's eye are resolved. Such movements may include horizontal movements left and right, vertical movements up and down, and diagonal movements.

FIG. 8 illustrates an example method 74A for detecting the visual stimulus received by the wearer of an HMD device. Method 74A may be a more particular instance of block 74 of method 68. In the embodiment illustrated in FIG. 8, the visual stimulus—real and/or virtual—may include imagery mapped to a geometric model accessible by the HMD device.

At 88 of method 74B, the wearer's line of sight within the geometric model is located. The wearer's line of sight may be located within the geometric model based partly on eye-tracker data and partly on positional data from one or more sensors arranged within the HMD device. The eye-tracker data establishes the wearer's line of sight relative to the reference frame of the HMD device and may further establish the wearer's focal plane. Meanwhile, the sensor data establishes the location and orientation of the HMD device relative to the geometric model. From the combined output of the eye trackers and the sensors, accordingly, the line of sight of the wearer may be located within the model. For example, it may be determined that the line of sight of the left eye of the wearer originates at model coordinates (X₀, Y₀, _{Z0}) and is oriented a degrees from north and β degrees from the horizon. When binocular eye-tracker data is combined with sensor data, the coordinates of the wearer's focal point may be determined.

At 90 the model in which the relevant imagery is mapped is subscribed to in order to identify the imagery that the wearer is currently sighting. In other words, the data server that hosts the model may be queried for the identity of the object that the wearer is sighting. In one example, the input for the query may be the origin and orientation of the wearer's line of sight. In another example, the input may be the wearer's focal point or focal plane.

FIG. 9 illustrates another example method 74B for detecting the visual stimulus received by a wearer of an HMD device. Method 74B may be another, more particular instance of block 74 of method 68. At 92 the wearer's FOV is imaged by a vision system arranged in the HMD device. In embodiments in which the vision system is configured for depth sensing, a depth map corresponding to the FOV may be constructed.

At 94 real imagery sighted by the wearer is recognized. For this purpose, any suitable object recognition approach may be employed, including approaches based on analysis of 3D depth maps.

The reader will appreciate that aspects of method 74A may be used together with aspects of method 746 in an overall method to assess a wearer's attentiveness to visual stimuli received through the HMD device. For instance, if the HMD device provides object recognition capabilities, then the mapping subscribed to in method 74A may be updated to include newly recognized objects not represented in the model as subscribed to.

Accordingly, at 96 of method 746, a geometric model of wearer's environment is updated. The updated mapping may then be uploaded to the server for future use by the wearer and/or other HMD-device wearers. Despite the advantages of the combined approach referred to presently, it will be emphasized that methods 74A and 746 may be used independently of each other. In other words, object recognition may be used independently of geometric model subscription, and vice versa.

FIG. 10 illustrates an example method 76A to correlate an ocular state of the wearer of an HMD device to the wearer's attentiveness to the visual stimulus received through the HMD device. Method 76A may be a more particular instance of block 76 of method 68.

At 98 of method 76A, prolonged focus on the visual stimulus is correlated to increased attentiveness to the visual stimulus. In other words, wearer attentiveness may be defined as a function that increases monotonically with increasing focal duration. At 100 decreased iris closure is correlated to increased attentiveness to the visual stimulus. Here, the wearer attentiveness is defined as a function that increases monotonically with decreasing iris closure. Naturally, the wearer-attentiveness function can be multivariate, depending both on focal duration and iris closure in the manner set forth above.

Further correlations are possible in embodiments in which one or more saccadic movements of the wearer's eye are resolved. In other words, the one or more saccadic movements resolved may be correlated to the wearer's attentiveness to the visual stimulus received through the HMD device. For example, at 102 of method 76A, increased saccadic frequency with the eye focused on the visual stimulus is correlated to increased attentiveness to the visual stimulus. At 104 increased fixation length between consecutive saccadic movements, with the eye focused on the visual stimulus, is correlated to increased attentiveness to the visual stimulus. One or both of these correlations may also be folded into a multivariate wearer-attentiveness function.

Method 76A is not intended to be limiting in any sense, for other correlations between attentiveness and the ocular state of the HMD-device wearer may be used as well. For instance, a measured length of observation of a visual target may be compared against an expected length of observation. Then, a series of actions may he taken if the measured observation length is different from the expected.

Suppose, for example, that the HMD-device wearer is on foot and encounters an advertising billboard. The billboard contains an image, a six word slogan, and a phone number or web address. An expected observation time for the billboard may be three to five seconds, which enables the wearer to see the image, read the words and move on. If the measured observation time is much shorter than the three-to-five second window, then it may be determined that the wearer either did not see the billboard or did not care about its contents. If the measured observation time is within the expected window, then it may be determined that the wearer has read the advert, but had no particular interest in it. However if the measured observation time is significantly longer than expected, it may be determined that the wearer has significant interest in the content.

Additional actions may then be taken depending on the determination made. In the event that the wearer's interest is determined to be significant, a record may be updated to reflect general interest in the type of goods or services being advertized. The phone number or web address from the billboard may be highlighted to facilitate contact, or, content from web address may be downloaded to a browser running on the HMD device. In contrast, if the wearer's interest is at or below the expected level, it is likely that no further action may be taken. In some instances, a record may be updated to reflect a general lack of interest in the type of goods or services being advertized.

The methods described herein may be tied to an AR system, which includes a computing system of one or more computers. These methods, and others embraced by this disclosure, may be implemented as a computer application, service, application programming interface (API), library, and/or other computer-program product.

FIGS. 1 and 5 show components of an example computing system to enact the methods described herein—e.g., cloud 14 of FIG. 1, and controller 24 of FIG. 5. As an example, FIG. 5 shows a logic subsystem 54 and a data-holding subsystem 56; cloud 14 also includes a plurality of logic subsystems and data-holding subsystems.

As shown in FIG. 5, various code engines are distributed between logic subsystem 54 and data-holding subsystem 56. These code engines correspond to different functional aspects of the methods here described; they include display engine 106, ocular-state detection engine 108, visual-stimulus detection engine 110, correlation engine 112, and report engine 114 with privacy filter 116. The display engine is configured to control the display of computer-generated imagery on HMD device 16. The ocular-state detection engine is configured to detect the ocular state of the wearer of the HMD device. The visual stimulus detection engine is configured to detect the visual stimulus—real or virtual—being received by the wearer of the HMD device. The correlation engine is configured to correlate the detected ocular state of the wearer to the wearer's attentiveness to the visual stimulus received, both when the visual stimulus includes real imagery in the wearer's field of view, and when the visual stimulus includes virtual imagery added to the wearer's field of view by the HMD device. The report engine is configured to report the wearer's attentiveness, as determined by the correlation engine, to one or more interested parties, wearer to the constraints of privacy filter 116.

Logic subsystem 54 may include one or more physical devices configured to execute instructions. For example, the logic subsystem may be configured to execute instructions that are part of one or more applications, services, programs, routines, libraries, objects, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud-computing system.

Data-holding subsystem 56 may include one or more physical, non-transitory, devices configured to hold data and/or instructions executable by the logic subsystem to implement the herein described methods and processes. When such methods and processes are implemented, the state of the data-holding subsystem may be transformed—to hold different data, for example.

Data-holding subsystem 56 may include removable media and/or built-in devices. The data-holding subsystem may include optical memory devices (CD, DVD, HD-DVD, Blu-Ray Disc, etc.), semiconductor memory devices (RAM, EPROM, EEPROM, etc.) and/or magnetic memory devices (disk drive, tape drive, MRAM, etc.), among others. The data-holding subsystem may include devices with one or more of the following characteristics: volatile, nonvolatile, dynamic, static, read/write, read-only, random access, sequential access, location addressable, file addressable, and content addressable. In some embodiments, the logic subsystem and the data-holding subsystem may be integrated into one or more common devices, such as an application specific integrated circuit (ASIC), or system-on-a-chip.

Data-holding subsystem 56 may also include removable, computer-readable storage media used to store and/or transfer data and/or instructions executable to implement the herein described methods and processes. The removable, computer-readable storage media may take the form of CDs, DVDs, HD-DVDs, Blu-Ray Discs, EEPROMs, and/or removable data discs, among others.

It will be appreciated that data-holding subsystem 56 includes one or more physical, non-transitory devices. In contrast, in some embodiments aspects of the instructions described herein may be propagated in a transitory fashion by a pure signal—e.g., an electromagnetic or optical signal—that is not held by a physical device for at least a finite duration. Furthermore, certain data pertaining to the present disclosure may be propagated by a pure signal.

The terms ‘module,’ ‘program,’ and ‘engine’ may be used to describe an aspect of a computing system that is implemented to perform a particular function. In some cases, such a module, program, or engine may be instantiated via logic subsystem 54 executing instructions held by data-holding subsystem 56. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms ‘module,’ ‘program,’ and ‘engine’ are meant to encompass individual or groups of executable files, data files, libraries, drivers, scripts, database records, etc.

It will be appreciated that a ‘service’, as used herein, may be an application program executable across multiple user sessions and available to one or more system components, programs, and/or other services. In some implementations, a service may run on a server responsive to a request from a client.

When included, a display subsystem may be used to present a visual representation of data held by data-holding subsystem 56. As the herein described methods and processes change the data held by the data-holding subsystem, and thus transform the state of the data-holding subsystem, the state of the display subsystem may likewise be transformed to visually represent changes in the underlying data. The display subsystem may include one or more display devices utilizing virtually any type of technology. Such display devices may be combined with logic subsystem 54 and/or data-holding subsystem 56 in a shared enclosure, or such display devices may be peripheral display devices.

When included, a communication subsystem may be configured to communicatively couple the computing system with one or more other computing devices. The communication subsystem may include wired and/or wireless communication devices compatible with one or more different communication protocols. As non-limiting examples, the communication subsystem may be configured for communication via a wireless telephone network, a wireless local area network, a wired local area network, a wireless wide area network, a wired wide area network, etc. In some embodiments, the communication subsystem may allow the computing system to send and/or receive messages to and/or from other devices via a network such as the Internet

It will be understood that the articles, systems, and methods described hereinabove are embodiments—non-limiting examples for which numerous variations and extensions are contemplated as well. Accordingly, this disclosure includes all novel and non-obvious combinations and sub-combinations of the articles, systems, and methods disclosed herein, as well as any and all equivalents thereof.

1. A method for assessing attentiveness to visual stimuli, comprising:
with a first detector arranged in a head-mounted display device, detecting an ocular state of the wearer of the head-mounted display device while the wearer is receiving a visual stimulus;
with a second detector arranged in the head-mounted display device, detecting the visual stimulus; and
correlating the ocular state to the wearer's attentiveness to the visual stimulus.

2. The method of claim 1 further comprising reporting the wearer's attentiveness to the stimulus.

3. The method of claim 1 wherein detecting the ocular state includes imaging the wearer's eye 240 or more times per second.

4. The method of claim 1 wherein the visual stimulus includes real imagery in the wearer's field of view.

5. The method of claim 1 wherein the visual stimulus includes virtual imagery added to the wearer's field of view via the head-mounted display device.

6. The method of claim 1 wherein detecting the visual stimulus includes depth sensing.

7. The method of claim 1 wherein the visual stimulus includes imagery mapped to a model accessible by the head-mounted display device, and wherein detecting the visual stimulus includes:
locating the wearer's line of sight within that model; and
subscribing to the model to identify the imagery that the wearer is sighting.

8. The method of claim 7 wherein the wearer's line of sight is located within the model based partly on positional data from one or more sensors arranged within the head-mounted display device.

9. The method of claim 1 wherein detecting the visual stimulus includes recognizing real imagery sighted by the wearer.

10. The method of claim :1 wherein detecting the ocular state includes detecting an orientation of a pupil of the wearer.

11. The method of claim 1 wherein detecting the ocular state includes detecting an extent of closure of an iris of the wearer.

12. The method of claim 1 wherein correlating the ocular state to the wearer's attentiveness includes:
correlating prolonged focus on the visual stimulus to increased attentiveness; or
correlating decreased iris closure to increased attentiveness.

13. A method for assessing attentiveness to visual stimuli, comprising:
with a detector arranged in a head-mounted display device, imaging an eye of a wearer of the head-mounted display device 240 or more times per second while the wearer is receiving a visual stimulus;
based on the imaging of the wearer's eye, detecting an ocular state of the wearer, which includes resolving one or more saccadic movements of the wearer's eye; and
correlating the one or more saccadic movements to the wearer's attentiveness to the visual stimulus.

14. The method of claim 13 wherein correlating the one or more saccadic movements to the wearer's attentiveness includes correlating increased saccadic frequency with the eye focused on the visual stimulus to increased attentiveness.

15. The method of claim 13 wherein correlating the one or more saccadic movements to the wearer's attentiveness includes correlating increased fixation length between consecutive saccadic movements with the eye focused on the visual stimulus to increased attentiveness.

16. A system for assessing attentiveness to visual stimuli, comprising:
a head-mounted display device including a detector arranged therein, the detector configured to detect an ocular state of a wearer of the head-mounted display device when the wearer is receiving a visual stimulus; and
a correlation engine configured to correlate the ocular state to the wearer's attentiveness to the visual stimulus, both when the visual stimulus includes real imagery in the wearer's field of view, and when the visual stimulus includes virtual imagery added to the wearer's field of view by the head-mounted display device.

17. The system of claim 16 wherein the detector is configured to image the wearer's eye 240 or more times per second.

18. The system of claim 16 wherein the detector is one of a plurality of detectors arranged in the head-mounted display device, the plurality of detectors also including an inertial sensor and/or a global-positioning system receiver configured to locate the wearer's line of sight within a model accessible by the head-mounted display device.

19. The system of claim 16 wherein the detector is one of a plurality of detectors arranged in the head-mounted display device, the plurality of detectors also including a camera configured to detect the real imagery.

20. The system of claim 19 wherein the camera is a depth camera.
